(19) United States
(12) Patent Application Publication
(10) Pub. No.: US 2024/0314428 A1
(43) Pub. Date: Sep. 19, 2024

(54) ADAPTIVE CAMERA SCHEME FOR LOW POWER SLAM IN XR

(71) Applicant: MEDIATEK, INC., Hsinchu (TW)

(72) Inventors: Yang-Tzu LIU TSEN, Hsinchu (TW); Chun Chen LIN, Hsinchu (TW); Tung-Chien CHEN, Hsinchu (TW); Chia-Da LEE, Hsinchu (TW); Jia-Ren CHANG, Hsinchu (TW); Deep YAP, Singapore (SG); Wai Mun WONG, Singapore (SG); Yi Cheng LU, Hsinchu (TW); Chia-Ming CHENG, Hsinchu (TW)

(73) Assignee: MEDIATEK, INC., Hsinchu (TW)

(21) Appl. No.: 18/600,124

(22) Filed: Mar. 8, 2024

Related U.S. Application Data
(60) Provisional application No. 63/490,301, filed on Mar. 15, 2023.

(51) Int. Cl. H04N 23/667; G06T 7/00

(52) U.S. Cl. CPC H04N 23/667; G06T 7/0002; G06T 2207/10016; G06T 2207/30168

(57) ABSTRACT

A method for performing camera modality adaptation in a simultaneous localization and mapping (SLAM) device is provided. The SLAM device includes a camera sensor and a SLAM processor. The method includes acquiring data from the SLAM device, and determining, based on the acquired data, an operational condition of the SLAM device. The method also includes deciding, based on the determined operational condition, a camera modality for the SLAM device. The method further includes controlling, based on the decided camera modality, a camera modality of an image sequence inputted into the SLAM processor.

### CROSS REFERENCE TO RELATED APPLICATIONS

The present application claims priority to U.S. Provisional Application No. 63/490,301, filed on Mar. 15, 2023, which is incorporated herein by reference in its entirety.

### TECHNICAL FIELD

The present disclosure relates generally to extended reality (XR). In particular, the disclosure relates to enhanced simultaneous localization and mapping (SLAM) used in XR tracking.

### BACKGROUND

Simultaneous localization and mapping (SLAM) is a fundamental element in the operation of an extended reality (XR) apparatus, such as augmented reality (AR) and virtual reality (VR) systems. By continuously analyzing data from various sensors (for example, cameras, gyroscopes, accelerometers, etc.), a SLAM device enables the XR apparatus to determine its precise location in the physical environment in real time. As the XR apparatus moves, the SLAM device can dynamically establish and update a comprehensive map of the surrounding environment. By this way, the SLAM device can track the movements of the XR apparatus and the user wearing the XR apparatus within the mapped environment.

It is desirable to improve the performance of SLAM devices to help achieve more attractive XR experiences.

### SUMMARY

Aspects of the disclosure provide a method for performing camera modality adaptation in a simultaneous localization and mapping (SLAM) device. The SLAM device includes a camera sensor and a SLAM processor. The method includes acquiring data from the SLAM device, and determining, based on the acquired data, an operational condition of the SLAM device. The method also includes deciding, based on the determined operational condition, a camera modality for the SLAM device. The method further includes controlling, based on the decided camera modality, a camera modality of an image sequence inputted into the SLAM processor.

Aspects of the disclosure provide an apparatus for performing camera modality adaptation in a SLAM device. The SLAM device includes a camera sensor and a SLAM processor. The apparatus includes processing circuitry configured to acquire data from the SLAM device, determine, based on the acquired data, an operational condition of the SLAM device, decide, based on the determined operational condition, a camera modality for the SLAM device, and control, based on the decided camera modality, a camera modality of an image sequence inputted into the SLAM processor.

Aspects of the disclosure also provide a non-transitory computer-readable medium storing instructions. The instructions, when executed by a processor, can cause the processor to perform the above method for performing camera modality adaptation in a SLAM device.

Note that this summary section does not specify every embodiment and/or incrementally novel aspect of the present disclosure or claimed invention. Instead, the summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates typical requirements for a simultaneous localization and mapping (SLAM) device deployed in an extended reality (XR) apparatus, in accordance with embodiments of the disclosure;

FIG. 2A shows the 6-degree-of-freedom (6DoF) pose of an exemplary XR apparatus with a SLAM device deployed therein;

FIG. 2B shows exemplary fields of view of multiple cameras arranged in the SLAM device of the XR apparatus shown in FIG. 2A;

FIG. 2C shows an exemplary view range of one of the multiple cameras of FIG. 2B;

FIG. 3A shows an exemplary camera sensor configuration that can be used in a SLAM device;

FIG. 3B shows exemplary scenes captured by the camera sensor configuration shown in FIG. 3A;

FIG. 4A shows an exemplary camera sensor configuration that can be used in a SLAM device;

FIG. 4B shows exemplary scenes captured by the camera sensor configuration shown in FIG. 4A;

FIG. 5A shows an exemplary camera sensor configuration that can be used in a SLAM device;

FIG. 5B shows exemplary scenes captured by the camera sensor configuration shown in FIG. 5A;

FIG. 6 shows a graph depicting the relationship between different camera configurations and accuracy of a SLAM device, in accordance with embodiments of the disclosure;

FIG. 7 shows a block diagram of an exemplary apparatus for performing camera modality adaptation in a SLAM device, in accordance with one embodiment of the disclosure;

FIGS. 8A, 8B, 8C, and 8D illustrate exemplary operational conditions of a SLAM device, in accordance with embodiments of the disclosure;

FIG. 9 shows a flow chart of an exemplary procedure for performing camera modality adaptation in a SLAM device, in accordance with one embodiment of the disclosure;

FIG. 10 shows a block diagram of an exemplary apparatus for performing camera modality adaptation in a SLAM device, in accordance with one embodiment of the disclosure;

FIG. 11 shows a block diagram of an exemplary apparatus for performing camera modality adaptation in a SLAM device, in accordance with one embodiment of the disclosure; and

FIG. 12 shows a schematic block diagram of an exemplary apparatus that can incorporate the techniques disclosed herein.

### DETAILED DESCRIPTION OF EMBODIMENTS

The following disclosure provides different embodiments, or examples, for implementing various features of the provided subject matter. Specific examples of components and arrangements are described below to simplify the present disclosure. These are, of course, merely examples and are not intended to be limiting.

For example, the order of discussion of the steps as described herein has been presented for the sake of clarity. In general, these steps can be performed in any suitable order. Additionally, although each of the different features, techniques, and configurations, etc., herein may be discussed in different places of this disclosure, it is intended that each of the concepts can be executed independently of each other or in combination with each other. Accordingly, the present disclosure can be embodied and viewed in many different ways.

Furthermore, as used herein, the words “a,” “an,” and the like generally carry a meaning of “one or more,” unless stated otherwise.

To enhance the user experience with an extended reality (XR) apparatus, certain key requirements need to be met. Swift and precise tracking is essential to suppress potential motion sickness during XR interactions. Therefore, one crucial consideration is to maintain low-latency and high-accuracy tracking across essential components, including the user's head, hands, controllers, and eye movements.

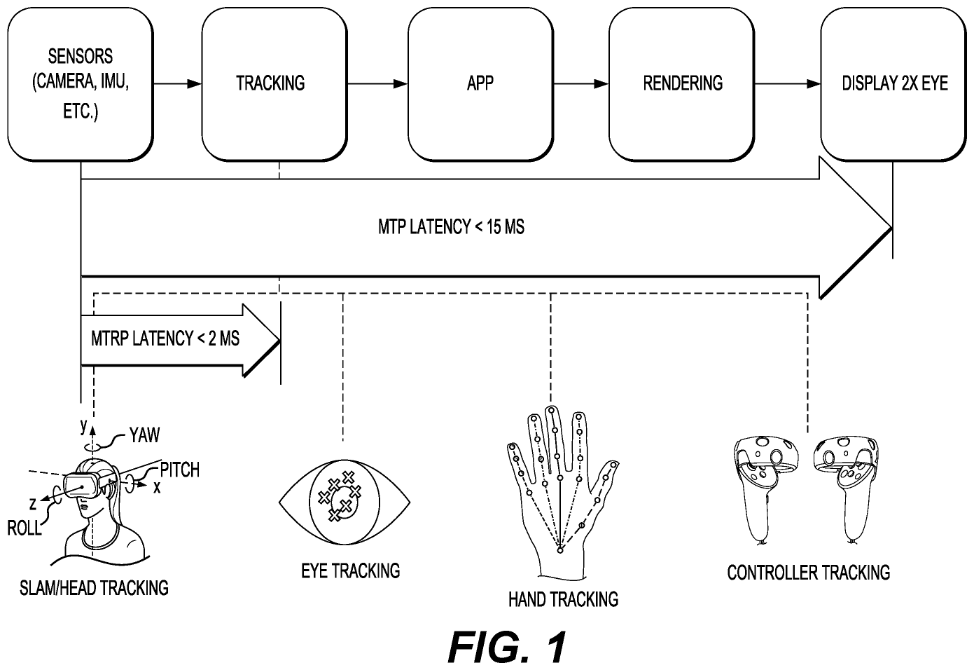

FIG. 1 illustrates the typical latency parameter requirements for a simultaneous localization and mapping (SLAM) device deployed in an XR apparatus, in accordance with embodiments of the disclosure. Specifically, the Motion-To-Realtime-Pose (MTRP) latency represents the duration for the SLAM device to detect a movement and accordingly update the virtual representation, including position and orientation. Furthermore, the Motion-To-Photon (MTP) latency represents the time from when the user makes a movement to the moment they perceive the corresponding change in the displayed content, i.e., the time taken for a movement to be translated into the final photons reaching the user's eyes.

Ideally, the MTRP latency should be less than 2 ms. Additionally, maintaining an MTP latency of less than 15 ms is desirable to ensure that the XR environment responds promptly to user actions. Moreover, for XR systems equipped with pose-prediction capabilities, the MTP latency can be further reduced to 0 ms, indicating virtually instantaneous translation of user movements into the XR environment.

When users engage in prolonged XR experiences, minimizing power consumption becomes important. This is particularly crucial for fanless XR systems, aiming for a sustained playtime of no less than three hours, for example. High energy efficiency not only enhances the overall user experience, but also facilitates uninterrupted XR engagement, allowing users to immerse themselves into XR content for extended durations without the inconvenience of frequent recharging.

Additionally, achieving outstanding display quality is important to alleviate the screen-door visual effect, thereby ensuring a seamless and immersive XR environment. Meeting these requirements can optimize performance and foster user comfort within XR systems, but requires to maintain a balance among competing factors.

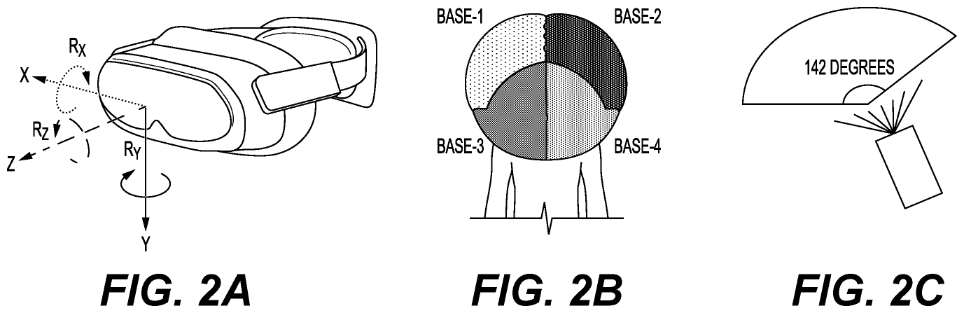

In FIG. 2A, a wearable headset is shown as an example of the XR apparatus with a SLAM device deployed therein. The 6-degree-of-freedom (6DoF) pose of the headset can be characterized by the position and orientation components acquired through the SLAM device, i.e., (x, y, z, Rx, Ry, Rz).

Specifically, the three position components (x, y, z) represent the SLAM device's position in the horizontal (along the x-axis), vertical (along the y-axis), and depth (along the z-axis) directions. Simultaneously, the three orientation components (Rx, Ry, Rz) represent the SLAM device's rotations around the x-axis, y-axis, and z-axis. These six parameters collectively define the pose of the SLAM device, and thus of the XR apparatus, in a three-dimensional (3D) space.

Accurate estimation and updating of the 6DoF pose are essential for the SLAM device, so as to facilitate environment mapping and tracking of the XR apparatus's movements within the 3D space. To achieve this, a combination of various sensors, including a camera sensor and an inertial measurement unit (IMU) sensor, is often used to acquire data for determining the pose of the SLAM device during SLAM operations.

The camera sensor equipped in the SLAM device can include a single or multiple cameras. FIG. 2B shows the fields of view of four cameras, i.e., Base-1, Base-2, Base-3, and Base-4, of the camera sensor. For instance, the cameras Base-1 and Base-2 can be positioned at the top edge of the XR apparatus shown in FIG. 2A, while the cameras Base-3 and Base-4 can be positioned at the bottom edge. Typically, these cameras are designed with wide-angle capabilities to maximize their ability to capture visual data of the surroundings. For example, a wide-angle camera as shown in FIG. 2C can provide a broad view range of 142 degrees.

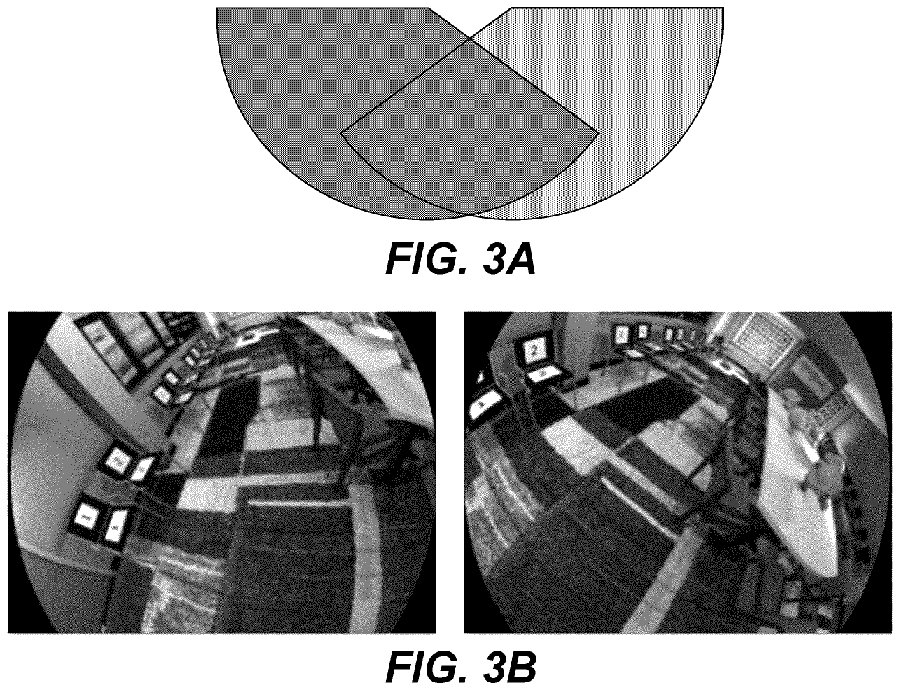

FIGS. 3A, 4A, and 5A show three different camera sensor configurations or modalities that can be used in a SLAM device. In FIG. 3A, a pair of stereo cameras is positioned at the bottom edge of the XR apparatus. In FIG. 3B, the camera sensor configuration includes two mono cameras at the top edge and a pair of stereo cameras at the bottom edge. In FIG. 3C, the configuration includes a pair of stereo cameras at both the top and bottom edges of the XR apparatus.

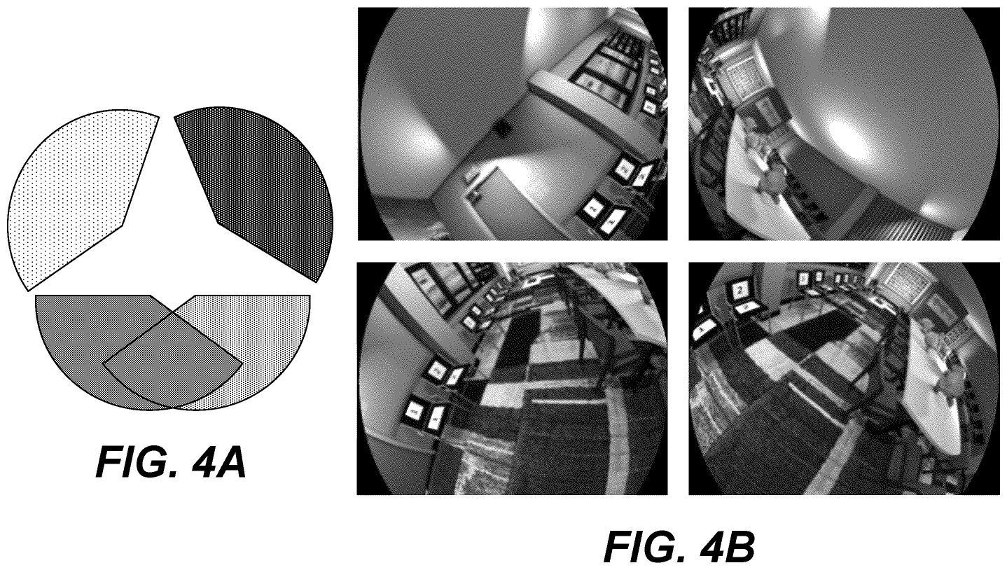

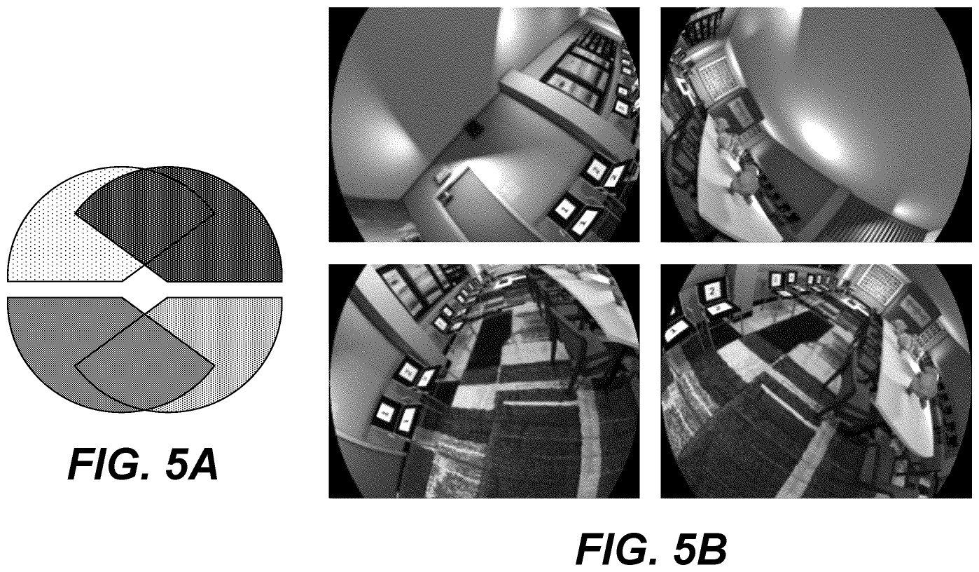

FIGS. 3B, 4B, and 5B show scenes captured by the camera sensor configurations shown in FIGS. 3A, 4A, and 5A, respectively. As shown in FIG. 3B, the pair of stereo cameras of FIG. 3A results in overlap within their fields of view, which facilitates the calculation of depth information in the captured scenes. Similarly, in FIG. 4B, there is overlap between the fields of view of the two bottom cameras, while no overlap exists between the fields of view of the two top cameras. In FIG. 5B, overlap can be observed both between the fields of view of the two bottom cameras and the two top cameras.

Table 1 presents various camera sensor configurations applicable to the SLAM device. Note that the camera sensor configurations listed in the table are illustrative and not exhaustive. Other various configurations are feasible.

TABLE 1

| Single-camera | Two-camera | Three-camera | Four-camera |
|---|---|---|---|
| configurations | configurations | configurations | configurations |
| 1 mono camera | 2 mono cameras | 1 pair of stereo | 1 pair of stereo |
| (at the top-left | (at the top | cameras (bottom) | cameras (bottom) |
| corner of the | edge of the | plus 1 mono | plus 2 mono |
| XR apparatus) | XR apparatus) | camera (top) | cameras (top) |
| 1 mono camera | 2 mono cameras | 1 pair of stereo | 2 pairs of stereo |
| (top-right) | (bottom) | cameras (top) | cameras (top; |
| | | plus 1 mono | bottom) |
| | | camera (bottom) | |
| 1 mono camera | 1 pair of stereo | | |
| (bottom-left) | cameras (top) | | |
| 1 mono camera | 1 pair of stereo | | |
| (bottom-right) | cameras (bottom) | | |

The selection of a camera sensor configuration not only impacts the visual perception capabilities of the SLAM device, but also affects the energy efficiency of the XR apparatus. The number of cameras in each configuration is directly proportional to the volume of visual data generated during SLAM operations. For example, two cameras capture two image sequences to be processed, while four cameras capture four image sequences. An increase in the number of cameras results in a more extensive visual data set, leading to increased computational efforts and power consumption. Since the power consumption of the SLAM device varies across different camera sensor configurations, it is desirable to adopt the most suitable camera setup in diverse operational conditions, ensuring an optimal balance between good visual perception and efficient energy utilization.

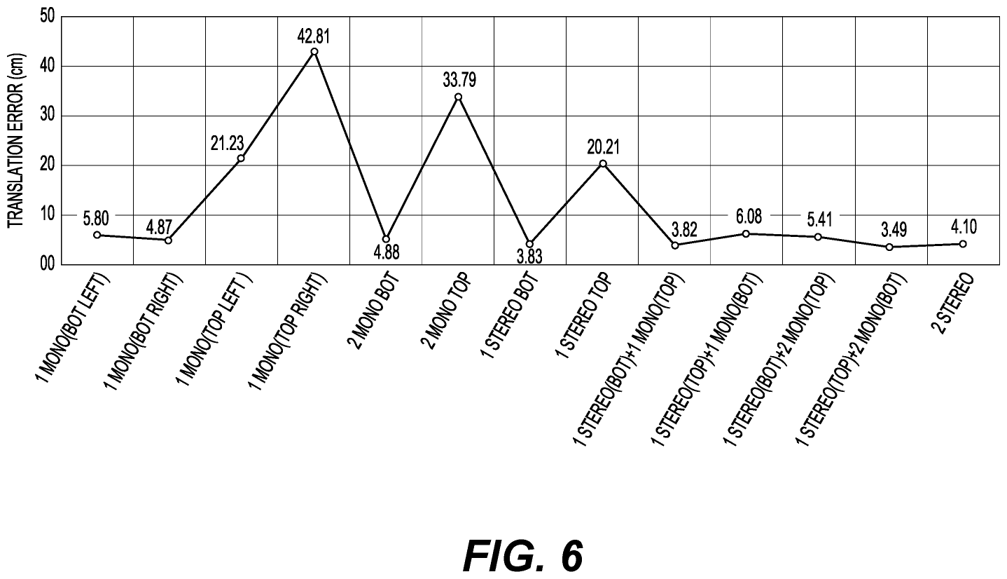

FIG. 6 shows a graph depicting the relationship between different camera configurations and the motion tracking accuracy of the SLAM device, tested under a specific operational condition. It can be observed that a translation error of 3.83 cm is achieved by a pair of stereo cameras positioned at the bottom edge of the XR apparatus. This level of accuracy is even better than that achieved with a higher number of cameras, such as two pairs of stereo cameras.

Therefore, it is not necessary to use all cameras within the camera sensor at all times. In contrast, by choosing a camera configuration appropriate to the current operational condition, it is possible for the SLAM device to maintain lower power consumption while still achieving sufficiently high accuracy.

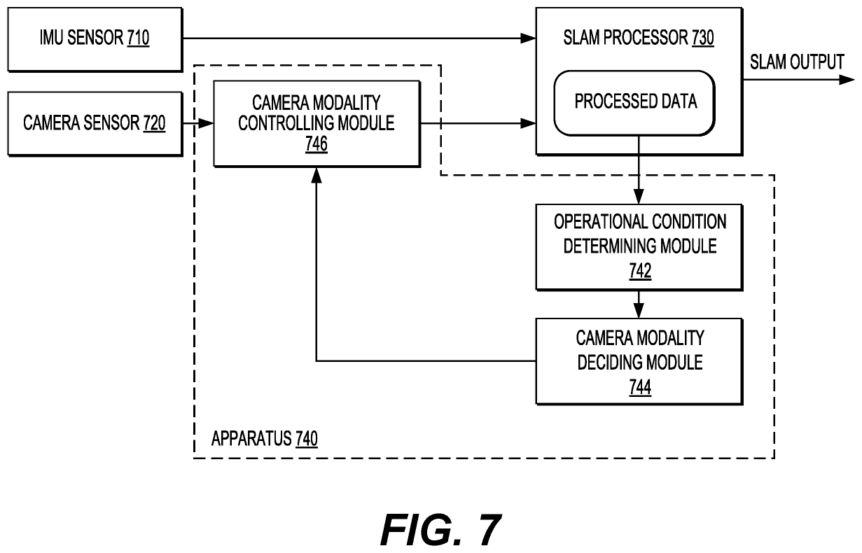

FIG. 7 shows a block diagram of an exemplary apparatus 740 for performing camera modality adaptation in a SLAM device, in accordance with one embodiment of the disclosure. The SLAM device can include an IMU sensor 710, a camera sensor 720, and a SLAM processor 730. The IMU sensor 710 measures accelerations and angular velocities using three-axis accelerometer and three-axis gyroscope, for example, to estimate the position and orientation of the SLAM device. Simultaneously, the camera sensor 720 captures an image sequence of the surrounding environment. The SLAM processor 730 acquires data sensed by the IMU sensor 710 and the camera sensor 720, and processes the acquired data to generate a SLAM output. Typically, the SLAM output can include a detailed map of the environment and information about the current estimated position and orientation of the SLAM device within that map.

The apparatus 740 for performing camera modality adaptation can be integrated within the SLAM device, or arranged outside of the SLAM device. The apparatus 740 includes an operational condition determining module 742, a camera modality deciding module 744, and a camera modality controlling module 746.

The operational condition determining module 742 acquires the data processed inside the SLAM processor 330. Based on this acquired data, the operational condition determining module 742 determines the current operational condition of the SLAM device, and sends it to the camera modality deciding module 744.

Based on the operational condition received from the operational condition determining module 742, the camera modality deciding module 744 decides a camera modality for the SLAM device and sends it to the camera modality controlling model 746.

The camera modality deciding module 744 can choose a camera modality from various camera modalities, such as using a pair of stereo cameras positioned at the top edge of the XR apparatus, using a pair of stereo cameras positioned at the bottom edge, using a pair of stereo cameras at the bottom edge plus a mono camera at the top edge, and using two pairs of stereo cameras at the bottom and top edges, etc.

The camera modality controlling module 746 can be coupled between the camera sensor 720 and the SLAM processor 730. Based on the camera modality received from the camera modality deciding module 744, the camera modality controlling module 746 regulates the data transmitted from the camera sensor 720 to the SLAM processor 730. For example, under the control of the camera modality controlling module 746, only the image sequences captured by certain cameras can be transmitted into the SLAM processor 730, while the image sequences captured by other cameras are discarded and thus will not be processed, so as to save the power consumption.

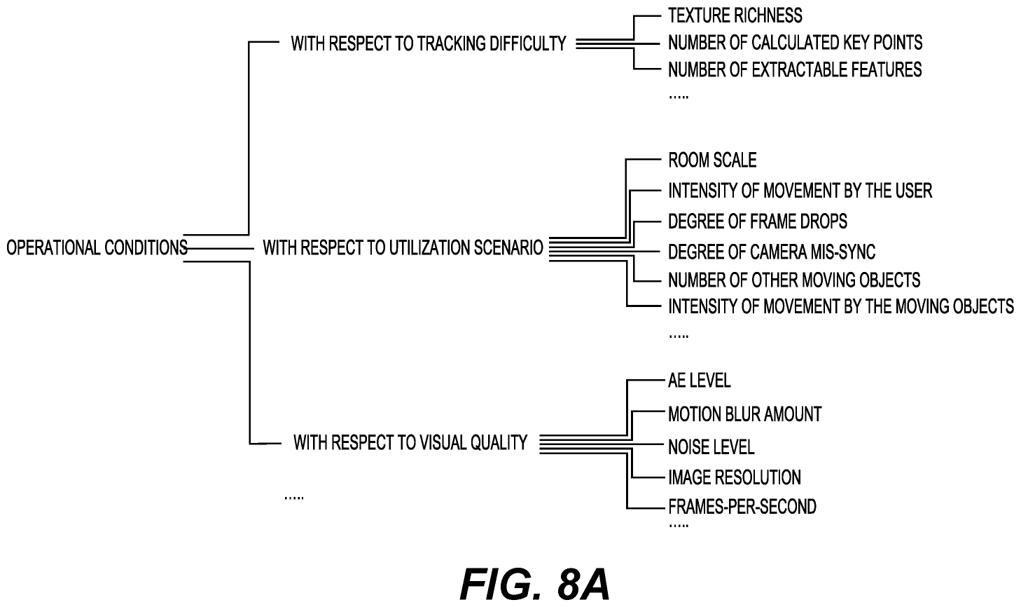

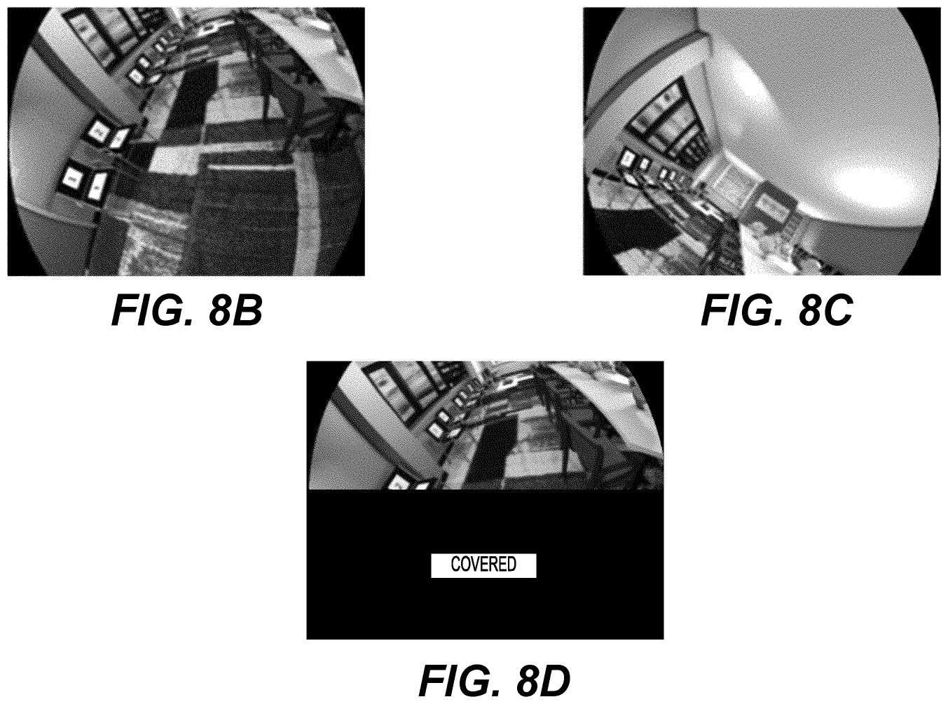

FIG. 8A shows exemplary operational conditions of the SLAM device, in accordance with embodiments of the disclosure. These operational conditions can involve the motion tracking difficulty of the current surrounding environment, which can be assessed based on factors such as the richness of texture within the captured scenes, the number of key points calculated from the captured scenes, the number of features extracted from the captured scenes via AI-based, CV-based, or any other appropriate approaches, etc.

For example, FIGS. 8B, 8C, and 8D illustrate three scenes with different motion tracking difficulties. In FIG. 8B, the carpet on the floor exhibits rich texture. In contrast, FIG. 8C has poor texture due to a substantial blank area on the ceiling. When some camera is obstructed, as shown in FIG. 8D, fewer key points or features can be identified from the captured scenes. As a result, the levels of tracking difficulty of FIGS. 8C and 8D are higher than that of FIG. 8B.

As another example, the operational conditions can be with respect to the utilization scenario of the SLAM device. This can include one or more factors such as the scale of the room where the XR apparatus is used, the intensity of movement by the user wearing the XR apparatus, the degree of frame drops in the SLAM device, the degree of camera mis-sync of the camera sensor, the number of other moving objects in the room, and the intensity of movement exhibited by these moving objects, etc.

Additionally, the operational conditions can involve the visual quality of the image sequences captured by the camera sensor. This can include aspects such as the level of auto exposure (AE) in the image sequences, the amount of motion blur in the image sequences, the level of noise in the image sequences, resolution of the image sequences, and a frames-per-second of the image sequences, etc.

Note that the operational conditions enumerated on FIG. 8A are exemplary and not restrictive. It is possible to adopt other specific operational conditions without deviating from the scope or spirit of the disclosure.

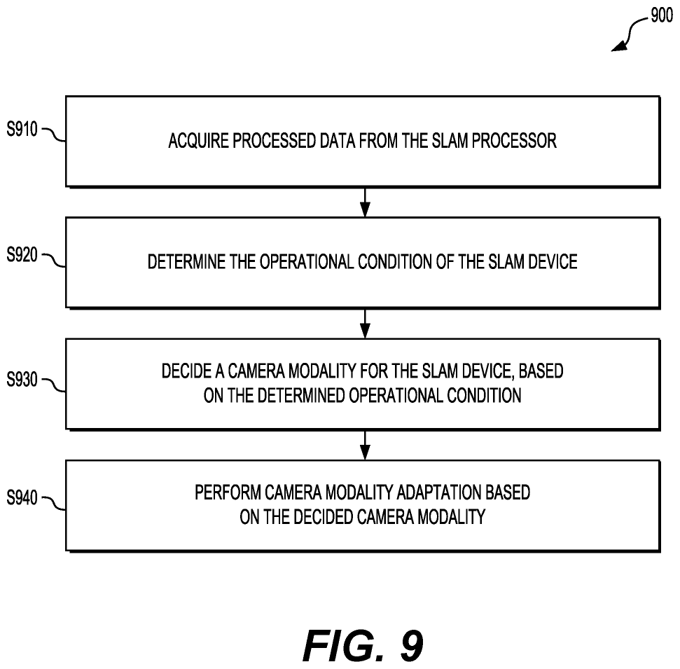

FIG. 9 shows a flow chart of an exemplary procedure 900 for performing camera modality adaptation in a SLAM device, in accordance with one embodiment of the disclosure. In step S910, processed data within the SLAM processor is acquired. Subsequently, in step S920, the operational condition of the SLAM device is determined based on the acquired data. Although FIG. 9 shows that the processed data within the SLAM processor is directly used as the acquired data, one skilled in the art can recognize that an analysis of the data acquired from the SLAM processor can be performed for the determination.

In step S930, a camera modality for the SLAM device is decided based on the determined operational condition. In step S940, camera modality adaptation is executed accordingly. Specifically, the data transmitted from the camera sensor to the SLAM processor can be regulated to align with the decided camera modality.

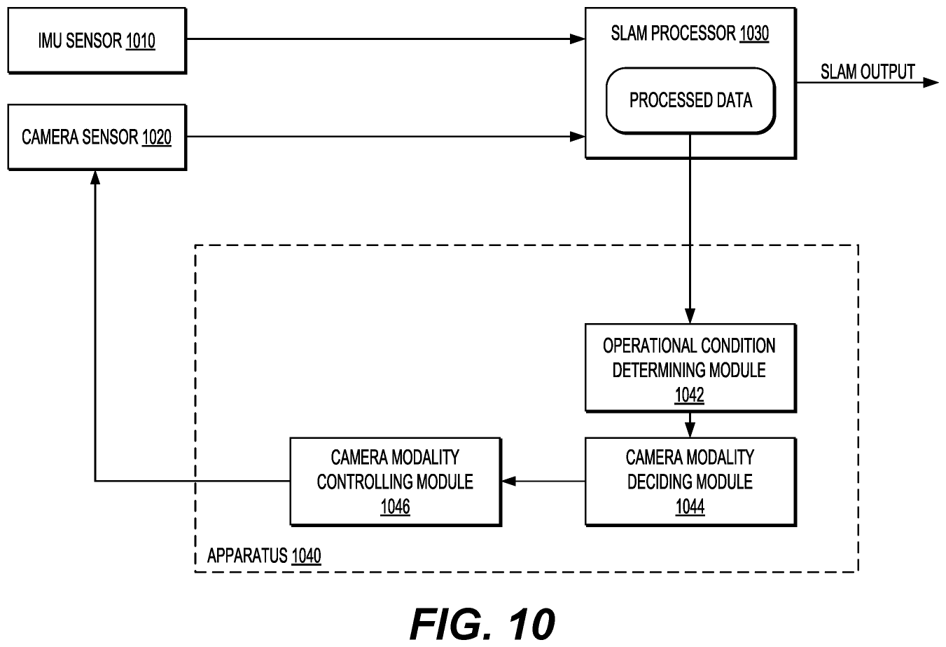

The approach of FIGS. 7 and 9 is merely illustrative and not restrictive. FIG. 10 shows a block diagram of an exemplary apparatus 1040 for performing camera modality adaptation in a SLAM device, in accordance with another embodiment of the disclosure. In the approach shown in FIG. 10, the apparatus 1040 includes an operational condition determining module 1042, a camera modality deciding module 1044, and a camera modality controlling module 1046.

The functions of the operational condition determining module 1042 and the camera modality deciding module 1044 are identical to those of the corresponding components of the apparatus 740 in FIG. 7. Instead of regulating the image sequences transmitted to the SLAM processor from specific cameras, camera modality adaptation can be implemented by directly activating or deactivating certain cameras within the camera sensor. Specifically, upon receiving the decided camera modality from the camera modality deciding module 1044, the camera modality controlling module 1046 can turn ON/OFF the cameras in the camera sensor 1020 accordingly, so as to match the camera modality decision.

While both embodiments depicted in FIGS. 7 and 10 use the processed data within the SLAM processor to determine the operational condition of the SLAM device, additionally or alternatively, this determination can be based on data acquired from other sources, such as data sensed by one or more sensors of the SLAM device.

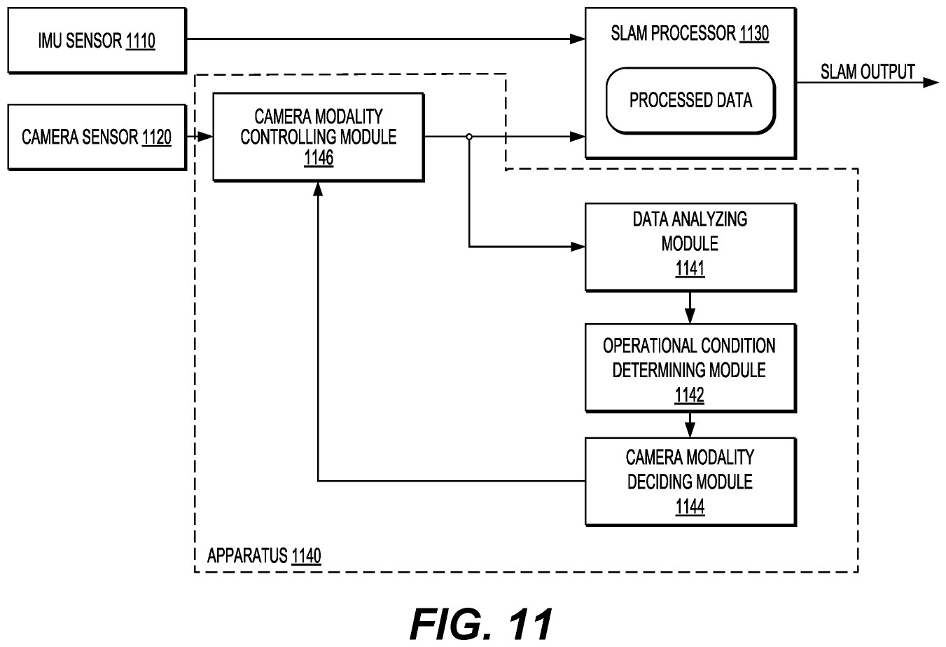

For example, the determination of the operational condition can be based on data acquired from the camera sensor. FIG. 11 shows a block diagram of an exemplary apparatus 1140 for performing camera modality adaptation in a SLAM device, in accordance with one embodiment of the disclosure. The apparatus 1140 includes a data analyzing module 1141, an operational condition determining module 1142, a camera modality deciding module 1144, and a camera modality controlling module 1146.

The data analyzing module 1141 receives and analyzes data sensed by the camera sensor 1120. Based on the data analysis performed by the data analyzing module 1141, the operational condition determining module 1142 determines the operational condition of the SLAM device. The functions of the camera modality deciding module 1144 and the camera modality controlling module 1146 are same as those of the corresponding components of the apparatus 740 shown in FIG. 7.

Similarly, in the embodiment illustrated in FIG. 11, the camera modality adaptation can be achieved by directly turning ON/OFF cameras included in the camera sensor, rather than regulating the image sequences transmitted from specific cameras to the SLAM processor.

The camera modality adaptation process described above can be carried out once after initializing the XR apparatus, serving as a calibration procedure before entering the regular usage phase. Additionally or alternatively, the camera modality can be dynamically adjusted throughout SLAM operations. For example, the camera modality adaptation can be triggered when a predefined criterion is met, such as the expiration of a predefined period, etc.

Therefore, under normal or standard operational conditions, the camera number can be configured to a value lower than the camera number used in corner cases, for example. By means of this camera modality adaptation mechanism, it is possible to achieve a balance between maintaining accuracy of the SLAM device and optimizing the energy efficiency of the XR apparatus.

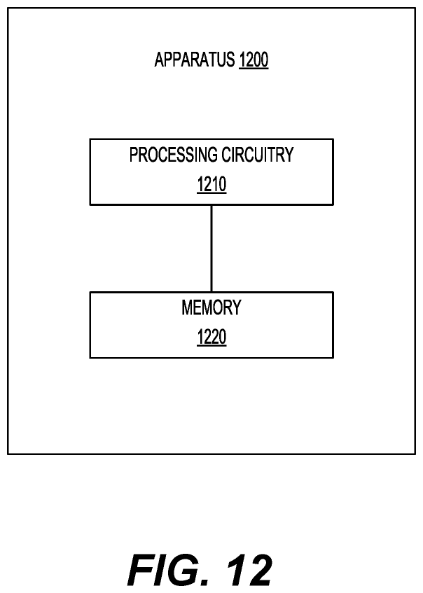

FIG. 12 shows a schematic block diagram of an exemplary apparatus that can incorporate the techniques disclosed herein. The apparatus 1200 can be configured to perform various functions in accordance with one or more embodiments or examples described herein. Thus, the apparatus 1200 can provide means for implementation of mechanisms, techniques, processes, functions, components, systems described herein.

For example, the apparatus 1200 can be used to implement functions of AI-based feature extractors, non-AI-based feature extractors, key-point detectors, key-point descriptors, KRF modules, AI-based feature extraction modules, add-on frameworks, modules in a V-SLAM system in various embodiments and examples described herein. The apparatus 1200 can include a general-purpose processor or specially designed circuits to implement various functions, components, or processes described herein in various embodiments. The apparatus 1200 can include processing circuitry 1210, and a memory 1220.

In various examples, the processing circuitry 1210 can include circuitry configured to perform the functions and processes described herein in combination with software or without software. In various examples, the processing circuitry 1210 can be a central processing unit (CPU), a graphic process unit (GPU), an accelerated processing unit (APU), a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 1210 can be a central processing unit (CPU) or an accelerated processing unit (APU) configured to execute program instructions to perform various functions and processes described herein. Accordingly, the memory 1220 can be configured to store program instructions. The processing circuitry 1210, when executing the program instructions, can perform the functions and processes. The memory 1220 can further store other programs or data, such as operating systems, application programs, and the like. The memory 1220 can include non-transitory storage media, such as a read only memory (ROM), a random access memory (RAM), a flash memory, a solid state memory, a hard disk drive, an optical disk drive, and the like.

The apparatus 1200 can optionally include other components, such as input and output devices, additional or signal processing circuitry, and the like. Accordingly, the apparatus 1200 may be capable of performing other additional functions, such as executing application programs, image processing algorithms, input or output data, or the like.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random-access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for performing camera modality adaptation in a simultaneous localization and mapping (SLAM) device, the SLAM device including a camera sensor and a SLAM processor, the method comprising:
acquiring data from the SLAM device;
determining, based on the acquired data, an operational condition of the SLAM device;
deciding, based on the determined operational condition, a camera modality for the SLAM device; and
controlling, based on the decided camera modality, a camera modality of an image sequence inputted into the SLAM processor.

2. The method of claim 1, wherein the acquiring step further comprises:
acquiring, as the acquired data, data processed inside the SLAM processor.

3. The method of claim 1, wherein the acquiring step further comprises:
receiving data outputted from the camera sensor to the SLAM processor, and analyzing the received data to generate the acquired data.

4. The method of claim 1, wherein the determining step further comprises determining, as the operational condition of the SLAM device, a motion tracking difficulty metric of a surrounding environment within which the SLAM device is used, and the motion tracking difficulty metric is evaluated based on at least one of:
richness of texture in an image sequence captured by the camera sensor,
a number of key points calculated from the image sequence, and
a number of feature extracted from the image sequence.

5. The method of claim 1, wherein the determining step further comprises determining, as the operational condition of the SLAM device, a visual quality of an image sequence captured by the camera sensor, and the visual quality includes at least one of:
a level of auto exposure in the image sequence,
an amount of motion blur in the image sequence,
a level of noise in the image sequence,
resolution of the image sequence, and
a frames-per-second of the image sequence.

6. The method of claim 1, wherein the determining step further comprises determining, as the operational condition of the SLAM device, a utilization scenario of the SLAM device, and the utilization scenario includes at least one of:
a scale of a room where the SLAM device is used,
an intensity of movement by a person wearing the SLAM device,
a degree of frame drops in the SLAM device,
a degree of camera mis-sync of the camera sensor,
a number of moving objects in the room, and
an intensity of movement by the moving objects.

7. The method of claim 1, wherein the deciding step further comprises:
upon the determined operational condition meeting a predefined criterion, choosing from a plurality of candidate camera modalities, a camera modality configured with fewer number of cameras compared with other candidate camera modalities.

8. The method of claim 1, wherein the controlling step further comprises:
selectively activating, based on the decided camera modality, cameras within the camera sensor.

9. The method of claim 1, wherein the controlling step further comprises:
selectively transmitting, based on the decided camera modality, image sequences captured by cameras within the camera sensor to the SLAM processor.

10. The method of claim 1, wherein the acquiring, determining, deciding, and controlling steps are executed upon the SLAM device being initiated, and/or upon a predefined criterion being met during SLAM operations of the SLAM device.

11. An apparatus for performing camera modality adaptation in a simultaneous localization and mapping (SLAM) device, the SLAM device including a camera sensor and a SLAM processor, the apparatus comprising processing circuitry configured to:
acquire data from the SLAM device;
determine, based on the acquired data, an operational condition of the SLAM device;
decide, based on the determined operational condition, a camera modality for the SLAM device; and
control, based on the decided camera modality, a camera modality of an image sequence inputted into the SLAM processor.

12. The apparatus of claim 11, wherein the processing circuitry is further configured to:
acquire, as the acquired data, data processed inside the SLAM processor.

13. The apparatus of claim 11, wherein the processing circuitry is further configured to:
receive data outputted from the camera sensor to the SLAM processor, and analyze the received data to generate the acquired data.

14. The apparatus of claim 11, wherein the processing circuitry is further configured to determine, as the operational condition of the SLAM device, a motion tracking difficulty metric of a surrounding environment within which the SLAM device is used, and the motion tracking difficulty metric is evaluated based on at least one of:
richness of texture in an image sequence captured by the camera sensor,
a number of key points calculated from the image sequence, and
a number of feature extracted from the image sequence.

15. The apparatus of claim 11, wherein the processing circuitry is further configured to determine, as the operational condition of the SLAM device, a visual quality of an image sequence captured by the camera sensor, and the visual quality includes at least one of:
a level of auto exposure in the image sequence,
an amount of motion blur in the image sequence,
a level of noise in the image sequence,
resolution of the image sequence, and
a frames-per-second of the image sequence.

16. The apparatus of claim 11, wherein the processing circuitry is further configured to determine, as the operational condition of the SLAM device, a utilization scenario of the SLAM device, and the utilization scenario includes at least one of:
a scale of a room where the SLAM device is used,
an intensity of movement by a person wearing the SLAM device,
a degree of frame drops in the SLAM device,
a degree of camera mis-sync of the camera sensor,
a number of moving objects in the room, and
an intensity of movement by the moving objects.

17. The apparatus of claim 11, wherein the processing circuitry is further configured to:
upon the determined operational condition meeting a predefined criterion, choose from a plurality of candidate camera modalities, a camera modality configured with fewer number of cameras compared with other candidate camera modalities.

18. The apparatus of claim 11, wherein the processing circuitry is further configured to:
selectively activate, based on the decided camera modality, cameras within the camera sensor.

19. The apparatus of claim 11, wherein the processing circuitry is further configured to:
selectively transmit, based on the decided camera modality, image sequences captured by cameras within the camera sensor to the SLAM processor.

20. A non-transitory computer readable medium including computer readable instructions, which, when executed by at least one processor, cause the at least one processor to perform a method for performing camera modality adaptation in a simultaneous localization and mapping (SLAM) device, the SLAM device including a camera sensor and a SLAM processor, the method comprising:
acquiring data from the SLAM device;
determining, based on the acquired data, an operational condition of the SLAM device;
deciding, based on the determined operational condition, a camera modality for the SLAM device; and
controlling, based on the decided camera modality, a camera modality of an image sequence inputted into the SLAM processor.
